(19) United States
(12) Patent Application Publication
(10) Pub. No.: US 2007/0008301 A1
(43) Pub. Date: Jan. 11, 2007

(54) Training system and method

(76) Inventors: Duncan Howard Stewart, Colorado Springs, CO (US); Matthew Bruce Hellier, Modesto, CA (US); Sebastian Hickey, Aiea, HI (US)

Correspondence Address: LAW OFFICE OF DALE B. HALLING, LLC, 655 SOUTHPOINTE CT, SUITE 100, COLORADO SPRINGS, CO, 80906, US

(21) Appl. No.: 11/471,442

(22) Filed: Jun. 20, 2006

Related U.S. Application Data
(60) Provisional application No. 60/692,492, filed on Jun. 21, 2005.

(51) Int. Cl. G09G 5/00

(52) U.S. Cl. 345/173

(57) ABSTRACT

A training system has a stylus. An electronic tablet detects a position of the stylus when the stylus is near a surface of the electronic tablet. A process defines a tolerance band on the electronic tablet.

### RELATED APPLICATIONS

The present invention claims priority on provisional patent application, Ser. No. 60/692,492 filed on Jun. 21, 2005, entitled “Writing Skills Training Device to Maintain Visual Attention” and is hereby incorporated by reference.

### FIELD OF THE INVENTION

The present invention relates generally to the field of teaching devices and more particularly to a training system and method.

### BACKGROUND OF THE INVENTION

Many children suffer from visual attention disorder (VAD). These children have wandering eyes and difficulty focusing on any task requiring eye/hand coordination. This is especially true when these children try to write and results in these children having an extremely difficult time learning to write. The current method of teaching these children how to write is a paper based system. The children are asked to draw a line between two related objects such as a bird and its nest. Therapists have found this paper system fails to grab the child's attention for more than a few minutes. Using this paper method is costly to the taxpayer, insurance companies, and to the parents due to the extended period of time it takes the student to learn to write.

Thus, there exists a need for a training system that is more effective at capturing the student's attention and decreases the time it takes them to learn to write.

### SUMMARY OF INVENTION

A training system that overcomes these and other problems has a stylus. An electronic tablet detects a position of the stylus when the stylus is near a surface of the electronic tablet. A process defines a tolerance band on the electronic tablet. The tolerance band may be defined by a visual marker. The process may define a starting position and an end position within the tolerance band. An audio cue may play while the stylus progresses from the starting position to the end position. A failure to progress may include going outside the tolerance band. A lesson generating program generates the process. A tracking and measuring program stores measurements based on the stylus movement. Using this system the child is given audio feedback and visual feedback of the progress they are making. This feedback captures the child's attention and increases the number of exercises they are willing to perform during a lesson with a therapist.

### BRIEF DESCRIPTION OF THE DRAWINGS

FIG. 1 is a perspective view of the training system in accordance with one embodiment of the invention;

FIG. 2 is an example of a writing template in accordance with one embodiment of the invention;

FIG. 3 is block diagram of the training system in accordance with one embodiment of the invention; and

FIG. 4 is a flow chart of the steps used in a method of operating a training system in accordance with one embodiment of the invention.

### DETAILED DESCRIPTION OF THE DRAWINGS

The present invention is a training system for children with visual attention disorder. The present invention uses an electronic tablet to create writing lessons. These lessons use both audio and visual feedback systems to engage the child in the writing task. Studies have shown that using this type of system immediately increases the child's attentiveness, which is the key to decreasing the time it takes these children to learn to write.

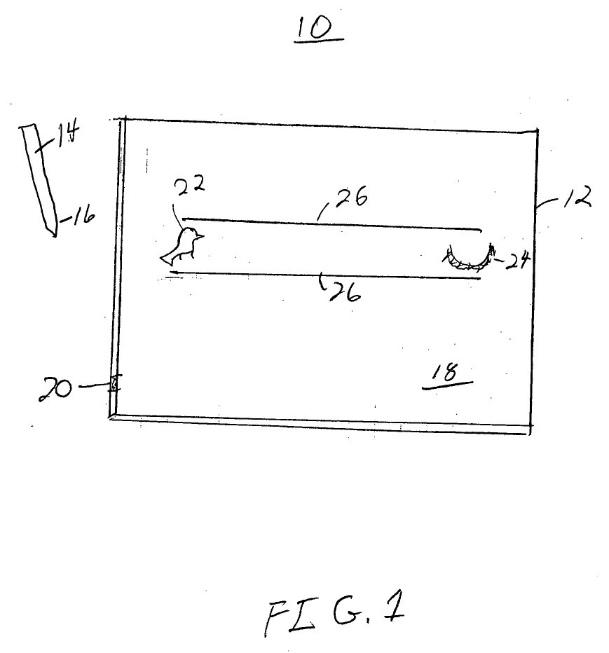

FIG. 1 is a perspective view of the training system 10 in accordance with one embodiment of the invention. The training system 10 includes an electronic tablet 12, which is a computer with an electronic writing surface. The electronic tablet 12 includes a stylus 14 and the electronic tablet senses when the tip 16 of the stylus 14 is on (or very near) the surface 18 the electronic tablet 12. The electronic tablet 12 has a speaker 20. A lesson is shown on the tablet 12. In this lesson a bird 22 defines a starting position and a nest 24 defines the ending position. A tolerance band 26 is defined by a pair of lines. In another embodiment, the tolerance band is defined by a color or shading. The student is asked to draw a line between the bird 22 and its next 24. In one embodiment when the student places the stylus 14 on the bird 22 music or some other audio cue starts to play. In another embodiment when the student places the stylus 14 on the bird 22 the bird starts to dance or some other animation is provided and the bird follows the stylus. As long as the student makes progress advancing the stylus from the starting position 22 to the end position 24 the music (or animation) continues to play. If the student stops making progress, the music stops or a different (failure mode) music plays and the student has to place the stylus on the starting position for the music to start again. Other failure modes include going outside the tolerance band 26, leaving the stylus in the same position for too long, moving the stylus back towards the staring position, picking the stylus up from the surface 18 of the tablet 12, and others that a therapist may want to define. Note, that in one embodiment if the stylus fails to make progress the bird returns to the starting position 22. If the student successfully draws a line from the bird to the nest, a success music may play or another animation may appear.

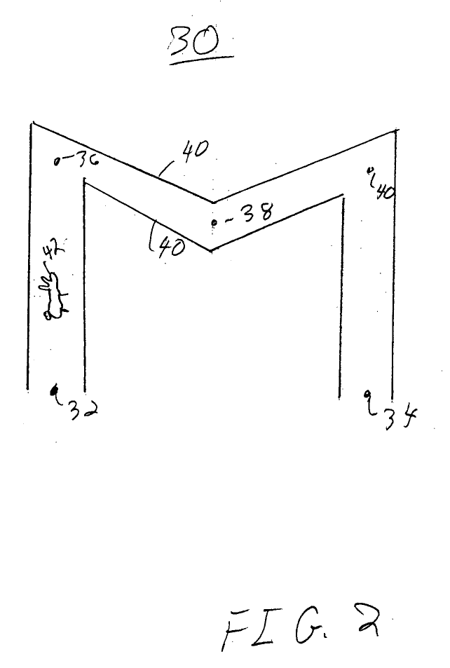

FIG. 2 is an example of a writing template 30 in accordance with one embodiment of the invention. This template 30 illustrates a more complex writing task. The template has a starting point 32 and an end point 34. However, because this is not a straight line or continuous circle the template has waypoints 36, 38, 40. Each waypoint can be considered a starting and an ending point. A pair of tolerance bands 40 are defined around the waypoints 32, 34, 36, 38, 40. A rabbit 42 or chase car feature is used to guide the child as he moves the stylus between the waypoints. The rabbit 42 stays in front of the stylus and the child is told to try to catch the rabbit. In one embodiment, the stylus is allowed to catch up to the rabbit at each waypoint.

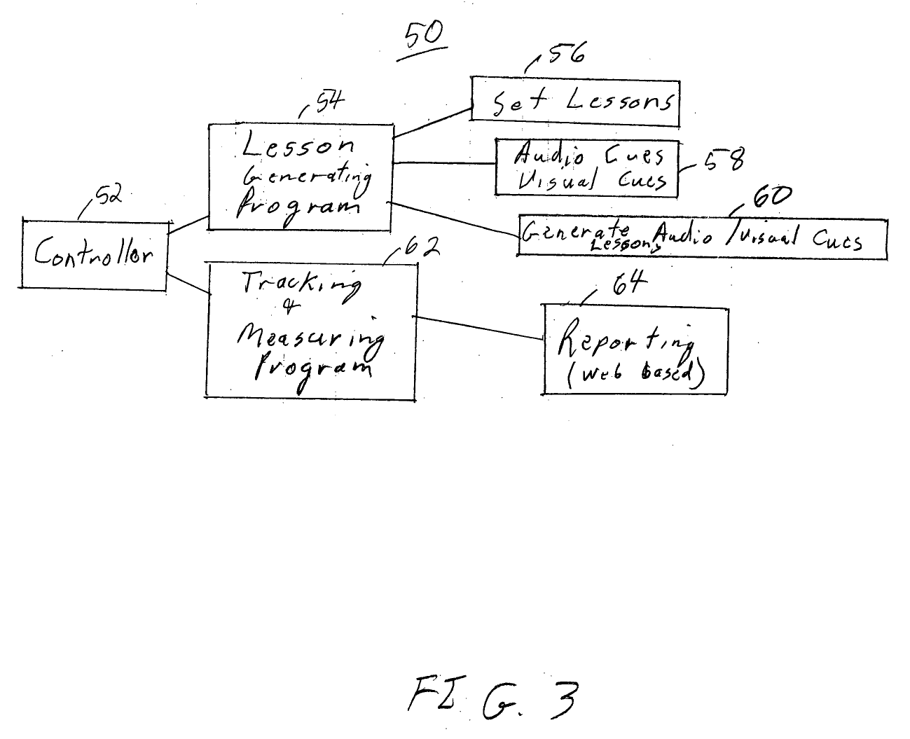

FIG. 3 is block diagram of the training system 50 in accordance with one embodiment of the invention. This block diagram 50 provides a high level understanding of the software used with the training system. A controller 52 provides the initial user interface and allows the therapist to setup the electronic tablet to perform the desired function. From the initial user interface the therapist can select a lesson generating program 54 creates the lessons for the students. The lesson generating program 54 includes a group of set lessons 56. The therapist can select any of these lessons for the student. In addition, the lesson generating program includes a number of audio and visual cues 58. These audio and visual cues 58, which can include animation, are used by the set lessons 56. In addition, the therapist can generate lessons 60. The generate lessons feature 60 allows the therapist to create shapes, alter tolerance bands, select predefined audio and visual cues or generate new audio or visual cues. The software also includes a tracking a measuring program 62. The therapist can define a profile for each student and then track their performance. The tracking and measuring program can track types of failures, success rates, how long it takes for the student to complete a task, statistic for these measurements and allows the therapist to add comments or subjective information including attentiveness. These measurements can be shared with parents and teachers or other therapist using the reporting feature 64. The reporting feature may be a web based transfer or storage of the measurements.

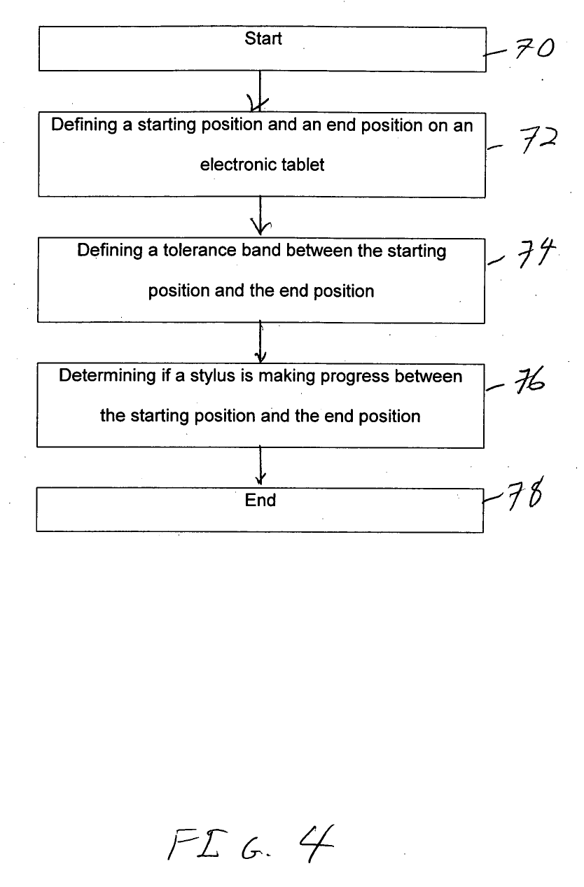

FIG. 4 is a flow chart of the steps used in a method of operating a training system in accordance with one embodiment of the invention. The process starts, step 70, by defining a starting position and an end position on an electronic tablet at step 72. A tolerance band between the starting position and the end position is defined at step 74. At step 76 it is determined if a stylus is making progress between the starting position and the end position which ends the process at step 78. When the stylus is making progress between the starting position and the end position an audio cue is played and progress is not being made the audio cue stops playing.

Thus there has been defined a training system and method that is interactive, that is more effective at capturing the student's attention and decreases the time it takes them to learn to write. This decrease the cost of teaching these students to write.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A training system, comprising:
a stylus;
an electronic tablet, the electronic tablet detecting a position of the stylus when the stylus is near a surface of the electronic tablet;
a process defining a tolerance band on the electronic tablet.

2. The system of claim 1, wherein the tolerance band is defined by a visual marker.

3. The system of claim 1, wherein the process defines a starting position and an end position within the tolerance band.

4. The system of claim 3, wherein an audio cue plays while the stylus progresses from the starting position to the end position.

5. The system of claim 4, wherein a failure to progress includes going outside the tolerance band.

6. The system of claim 1, further including a lesson generating program that when executed generates the process.

7. The system of claim 6, further including a tracking and measuring program storing measurements based on the stylus movement.

8. A training system, comprising:
an electronic tablet computer; and
a lesson generating program, each lesson including a tolerance band.

9. The system of claim 8, further including a tracking and measuring program collecting data from a lesson.

10. The system of claim 8, wherein the lesson generating program includes an audio cue component.

11. The system of claim 10, wherein the lesson generating program includes a visual cue component.

12. The system of claim 8, wherein one of the lessons includes a chase car feature.

13. The system of claim 8, wherein each lesson includes a starting position and an end position.

14. The system of claim 9, wherein the tracking and measuring program determines a fault condition.

15. A method of operating a training system, comprising:
a) defining a starting position and an end position on an electronic tablet;
b) defining a tolerance band between the starting position and the end position; and
c) determining if a stylus is making progress between the starting position and the end position.

16. The method of claim 15, further including the step of:
d) when the stylus is making progress between the starting position and the end position, playing an audio cue.

17. The method of claim 16, further including the step of:
e) when the stylus stops making progress between the starting position and the end position, not playing the audio cue.

18. The method of claim 15, wherein step (c) further includes the step of:
c1) determining that the stylus is not making progress if the stylus is outside the tolerance band.

19. The method of claim 15, wherein step (c) further includes the step of:
c1) determining that the stylus is not making progress if the stylus is removed from a surface of the electronic tablet.

20. The method of claim 15, wherein step (c) further includes the step of:
c1) determining that the stylus is not making progress if the stylus remains at a point beyond a predetermined period of time.
